(19) United States
(12) Patent Application Publication
(10) Pub. No.: US 2007/0172147 A1
(43) Pub. Date: Jul. 26, 2007

(54) Image processing apparatus, road image plotting method, and computer-readable recording medium for plotting a road image

(76) Inventors: Akihito Fujiwara, Tokyo (JP); Yasuhiro Hayashida, Tokyo (JP); Tsutomu Akazawa, Tokyo (JP)

Correspondence Address: LADAS & PARRY LLP, 224 SOUTH MICHIGAN AVENUE, SUITE 1600, CHICAGO, IL, 60604, US

(21) Appl. No.: 11/487,872

(22) Filed: Jul. 17, 2006

(30) Foreign Application Priority Data
Jul. 19, 2005 (JP) 2005-208757

(51) Int. Cl. G06K 9/36

(52) U.S. Cl. 382/276

(57) ABSTRACT

An image processing apparatus for displaying a three-dimensional map on a display is disclosed that includes an extracting part for extracting data corresponding to a part of a road covered behind a three-dimensional building by referring to depth information of a target plotting road and a target plotting building, and an overwriting part for overwriting the data corresponding to the covered road part with color data or pattern data that are distinguishable from color data or pattern data of the target plotting road and the target plotting building.

### BACKGROUND OF THE INVENTION

1. Field of the Invention

The present invention generally relates to an image processing apparatus, a road image plotting method, and a computer-readable recording medium for plotting a road image for application to, for example, an automobile navigation apparatus.

2. Description of the Related Art

In recent years and continuing, there is widespread use of automobile navigation apparatuses showing, for example, the current location and destination of the automobile on a map of a display screen of the automobile. Owing to the development of plotting technology, there is a growing demand for plotting the maps of the automobile navigation apparatuses three dimensionally (plotting of 3D automobile navigation maps). Here, plotting of 3D automobile navigation maps refers to plotting maps that show the road (serving as the main part of the map) while also showing three-dimensional buildings.

In order for the map of the car navigation apparatus to serve its purpose, the road has to be plotted (displayed) on the map of the car navigation apparatus. That is, the most important information for the driver is the road. However, in plotting the 3D automobile navigation maps, there is a problem where a three-dimensionally plotted building causes difficulty in viewing the road. For example, this occurs when a three-dimensionally plotted building hides (obstructs) a road that is situated behind the building.

In other words, when the positions of the roads and buildings are plotted as they are, the roads become partly or entirely covered by the buildings. As a result, the car navigation map cannot serve its purpose. For preventing such problems, the conventional car navigation apparatus uses the following methods.

In the first example, Japanese Laid-Open Patent Application No. 9-318381 discloses a method that semi-transparently plots a building situated in the front so that an object (e.g. road) behind the building can be seen.

In the second example, Japanese Laid-Open Patent Application No. 2000-293668 discloses a method that plots all of the roads semi-transparently and overwrites the semi-transparent roads on the buildings. By having the semi-transparent roads superposed on the buildings, the roads appear to be transparently seen through the buildings. FIG. 1 is a drawing for describing the conventional plotting method considering the overlapping of roads. and buildings. In FIG. 1, although a part of a road R overlaps a building B, the road R can be prevented from being partly or entirely covered by the building B by plotting the road R or the building B in a semi-transparent manner.

However, with the conventional methods of plotting the road or the building semi-transparently, the following problems are raised.

The method of the first example is effective only where the objects are overlapped in a one-on-one manner (i.e. one building vs. one road). In a case where multiple semi-transparent buildings are overlapped, the overlapping of multiple semi-transparent buildings reduces transparency and adversely affects visibility. As a result, the roads behind the buildings can hardly be seen.

With the method of the second example, although the user may be able to recognize the overlapping of the roads and the buildings, a considerable amount of image processing is required for plotting owing to the fact that the entire road is semi-transparently plotted.

### SUMMARY OF THE INVENTION

The present invention may provide an image processing apparatus, a method, and a computer-readable recording medium for plotting a road image that substantially obviate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by an image processing apparatus, a method, and a computer-readable recording medium for plotting a road image particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an image processing apparatus for displaying a three-dimensional map including roads and three-dimensional buildings on a display, the image processing apparatus including: an extracting part for extracting data corresponding to a part of a road covered behind a three-dimensional building by referring to depth information of a target plotting road and a target plotting building; and an overwriting part for overwriting the data corresponding to the covered road part with color data or pattern data that are distinguishable from color data or pattern data of the target plotting road and the target plotting building.

In the image processing apparatus according to an embodiment of the present invention, the depth information may be obtained from a Z buffer that stores information including the distance between a reference viewpoint and the target plotting road and the distance between the reference viewpoint and the target plotting building.

In the image processing apparatus according to an embodiment of the present invention, data corresponding to the covered road part may be loaded in a stencil buffer, wherein the data of the covered road part are overwritten in a frame buffer based on the data loaded in the stencil buffer.

Furthermore, another embodiment of the present invention provides a road image plotting method for an image processing apparatus displaying a three-dimensional map including roads and three-dimensional buildings on a display, the method including the steps of: extracting data corresponding to a part of a road covered behind a three-dimensional building by referring to depth information of a target plotting road and a target plotting building; and overwriting the data corresponding to the covered road part with color data or pattern data that are distinguishable from color data or pattern data of the target plotting road and the target plotting building.

Furthermore, another embodiment of the present invention provides a computer-readable recording medium on which a program for causing a computer to execute a road image plotting method is recorded, the road image plotting method including the steps of: extracting data corresponding to a part of a road covered behind a three-dimensional building by referring to depth information of a target plotting road and a target plotting building; and overwriting the data corresponding to the covered road part with color data or pattern data that are distinguishable from color data or pattern data of the target plotting road and the target plotting building.

Other objects and further features of the present invention will be apparent from the following detailed description when read in conjunction with the accompanying drawings.

### BRIEF DESCRIPTION OF THE DRAWINGS

FIG. 1 is a schematic diagram for describing a conventional plotting method considering the overlapping of roads and buildings;

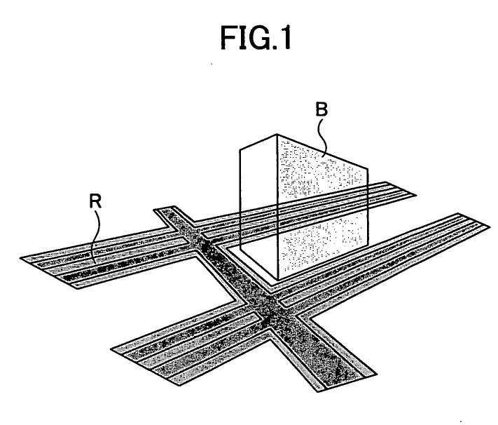

FIG. 2 is a schematic diagram showing an exemplary configuration of an automobile navigation apparatus according to an embodiment of the present invention;

FIG. 3 is a flowchart showing an exemplary operation of plotting a road image according to an embodiment of the present invention; and

FIG. 4 is a schematic diagram for describing a process of determining whether there is an overlapped part between a road and a building and a process of plotting the overlapped part between the road and the building according to an embodiment of the present invention.

### DESCRIPTION OF THE PREFERRED EMBODIMENTS

In the following, embodiments of the present invention will be described with reference to the accompanying drawings.

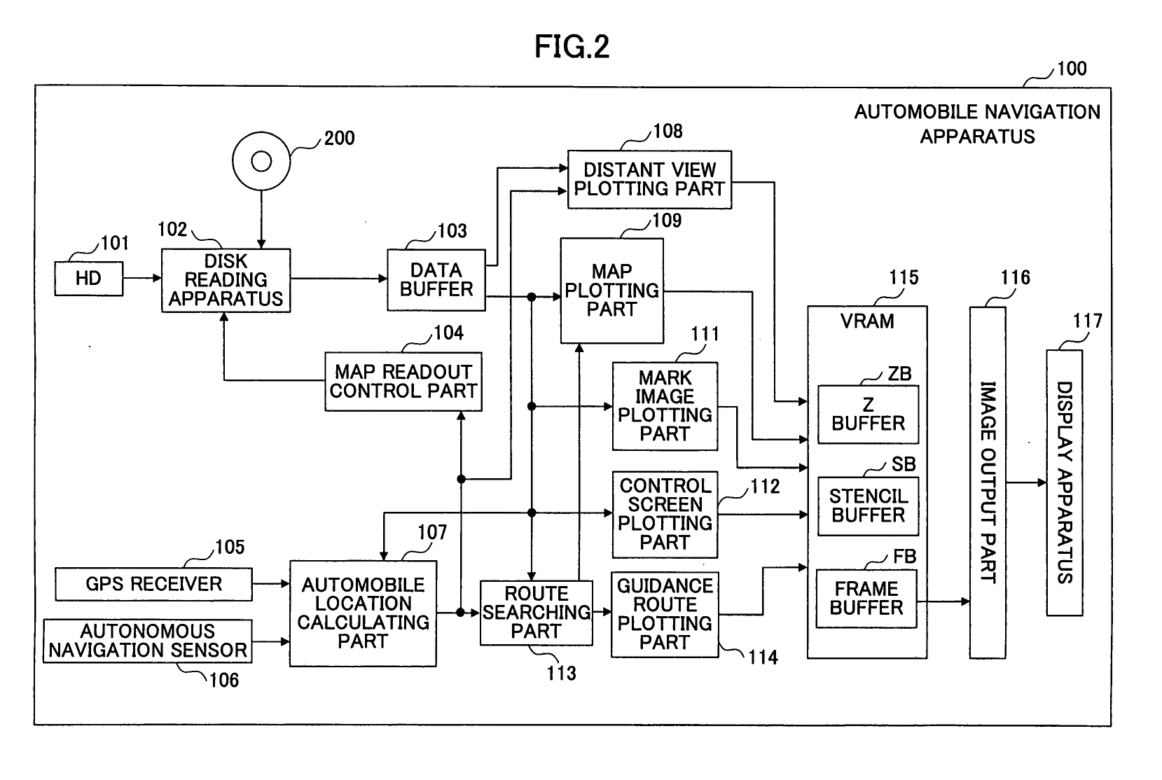

FIG. 2 is a schematic diagram showing an exemplary configuration of an image forming apparatus such as an automobile navigation apparatus 100 according to an embodiment of the present invention. In FIG. 2, the automobile navigation apparatus 100 includes a hard disk apparatus 101 for storing 3D map information (including information regarding display objects, such as icons), disk reading apparatus 102 for reading map information from the hard disk apparatus 101, a data buffer 103 for buffering the map information read out by the disk reading apparatus 102, and a map readout control part 104 for controlling the read out executed by the disk reading apparatus 102. It is to be noted that a computer-readable recording medium 200 such as a DVD (Digital Versatile Disc) apparatus or a CD (Compact Disc) apparatus may be used together with the hard disk apparatus 101 or as an alternative to the hard disk apparatus 101. Furthermore, the automobile navigation apparatus 100 also includes a GPS receiver 105 for obtaining location information of the automobile on which the automobile navigation apparatus 100 is mounted, an autonomous navigation sensor 106 for detecting, for example, the traveling direction, the acceleration, the velocity, the mileage of the automobile, and an automobile location calculating part 107 for calculating the location of the automobile based on the information detected by the autonomous navigation sensor 106. The information calculated by the automobile location calculating part 107 is delivered to the map readout control part 104. The map readout control part 104 instructs (controls) the disk readout apparatus 102 to read out the map information corresponding to the area that covers the location of the automobile.

Furthermore, the automobile navigation apparatus 100 also includes: a distant view plotting part 108 for plotting a distant view(s) in a frame buffer FB of a VRAM (Video Random Access Memory) 115 based on map information obtained from the data buffer 103 and automobile location information obtained from the automobile location calculating part 107; a map plotting part 109 for plotting a road(s) and a three-dimensional building(s) in the frame buffer FB of the VRAM 115 based on map information obtained from the data buffer 103; a mark image plotting part 111 for plotting a mark(s) (e.g. icon) in the frame buffer FB of the VRAM 115 based on the map information obtained from the data buffer 103; a control screen plotting part 112 for plotting a control screen in the frame buffer FB of the VRAM 115 based on the map information obtained from the data buffer 103; a route searching part 113 for searching for the optimum route for reaching a destination designated by the user based on map information obtained from the data buffer 103 and automobile location information obtained from the automobile location calculating part 107; and a guidance route plotting part 114 for plotting a guidance route in the frame buffer FB of the VRAM 115 based on the search results of the optimum route. Furthermore, the automobile navigation apparatus 100 includes: an image output part 116 for outputting distant view images, map images (e.g. roads, buildings), mark images (e.g. icons), control screen images, and guidance route images that are plotted in the frame buffer FB of the VRAM 115; and a display apparatus 117 for displaying composite images to be displayed to the user. It is to be noted that the VRAM 115 (besides having the frame buffer FB) also includes a Z buffer ZB and a stencil buffer SB. Although it is preferable to logically provide the corresponding spaces for the Z buffer ZB, the stencil buffer SB, and the frame buffer FB inside the VRAM 115, the spaces may be provided by preparing corresponding memories, respectively in the VRAM 115.

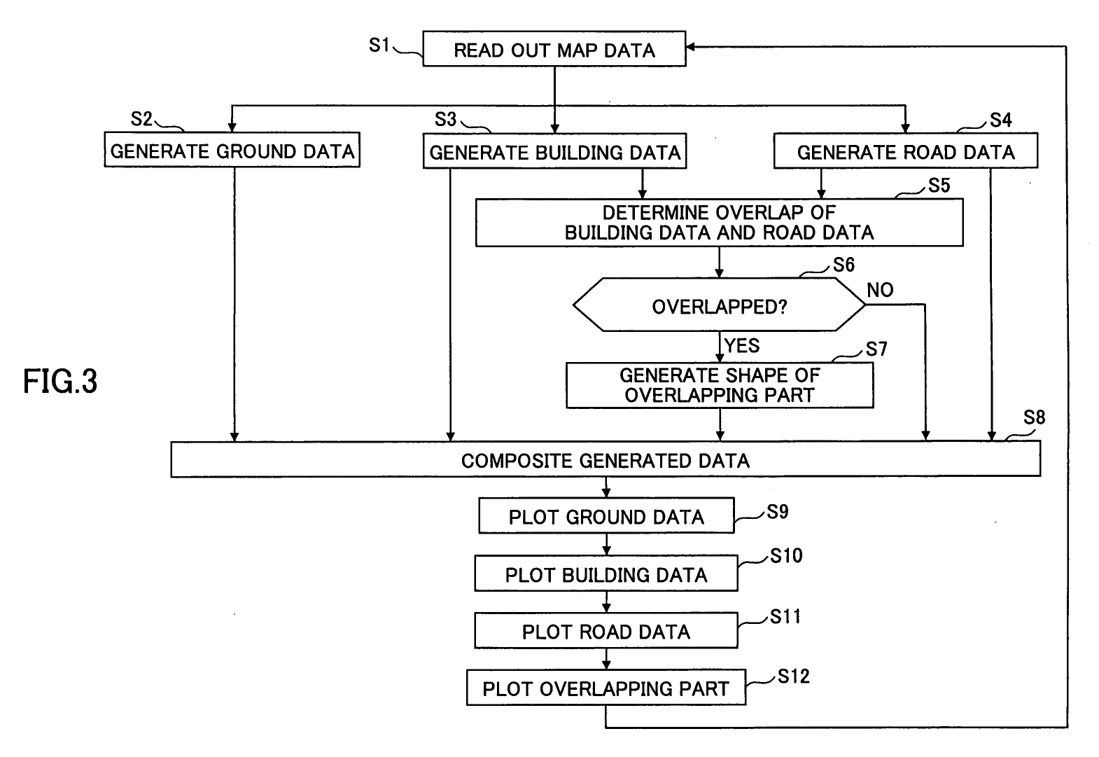

FIG. 3 is a flowchart showing an exemplary process of plotting a road image according to an embodiment of the present invention. This process is executed by software (computer program) in the map plotting part 109 shown in FIG. 2. In the process shown in FIG. 3, first, map data are read out (Step S1). Then, the steps of generating ground data (Step S2), generating building data (Step S3), and generating road data (Step S4) are executed in parallel. Then, a step of determining whether there are any overlapped parts is executed by referring to the generated building data and the generated road data (Step S5). Then, the part(s) determined to be overlapped in Step S5 is detected (Step S6). Then, a step of generating the shape of the overlapping part (overlap part data) when an overlapping part (Step S7) is detected. In a case where there is no overlapping part, no step is executed in particular.

Then, a step of compositing the generated ground data, the generated building data, the generated road data, and the generated overlap part data is executed (Step S8). After the compositing step is completed, the steps of plotting the ground data (Step S9), plotting the building data (Step S10), plotting the road data (Step S11), and plotting the overlap data (Step S12) are executed. Then, the process returns to the step of reading out map data (Step S1).

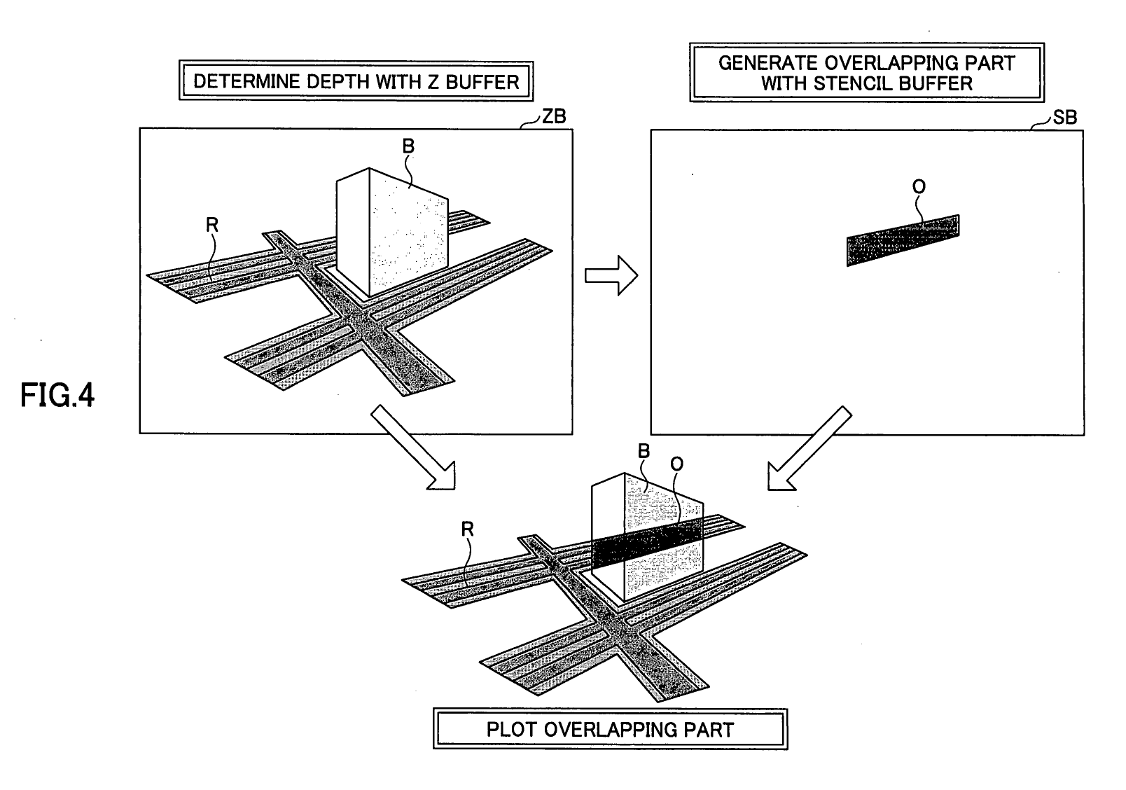

FIG. 4 is a schematic diagram for further explaining the steps of determining an overlapping part between a road and a building and plotting the overlapping part according to an embodiment of the present invention. In determining the overlapping part, depth information of the road data and the building data are obtained from the Z buffer ZB which stores information regarding the distance with respect to a given reference viewpoint(s) (camera position) for each pixel of the plotting targets (in this example, road R and building B). That is, the Z buffer ZB stores information regarding the distance between a given reference viewpoint(s) and the road R and the distance between a given viewpoint(s) and the building B. The overlap between the road R and the building B is determined based on which of the building data and the road data has a greater value. In other words, in a case where road data and building data exist at the same plotting position, it is determined that the road R and the building B overlap when the value of the depth information of the road data is greater than the value of the depth information of the building data. Accordingly, overlap data for indicating an overlapping part O is stored in the stencil buffer SB (e.g. stored as bit “1”). Then, after the road R and the building B are plotted, the overlapping part O is overwritten with a color (color data) and/or a pattern (pattern data) that can be distinguished from the color data or pattern data of the road R and the building B. Thereby, the overlapping part between the road R and the building B can be displayed in a recognizable manner. Alternatively, the information indicating the overlapping part does not have to be stored in the stencil buffer SB, for example, in a case where the value of the depth information of the road data is equal to or greater than a predetermined value (i.e. a case where the road R is situated a predetermined distance away from the viewpoint). This can prevent minor roads situated relatively far away from being plotted. Accordingly, the user will not be bothered by the existence of such minor roads. Furthermore, a road having some significance (e.g. a road displayed as part of a guidance route) may be displayed with yet another color (color data) or a pattern (pattern data) distinguishable from the overlapping part.

With the method of the present invention, the part of the road behind the building (overlapping part) can be displayed in a silhouette-like manner. With the method of the present invention, the workload of processing the image is less compared to displaying the entire road semi-transparently. Although the overlapping part O is displayed as a silhouette of the covered road rather than distinguishably showing the sidewalks or the central divider included in the covered road R, the display is easier to comprehend compared to plotting all of the roads semi-transparently as in the above-described second example.

Accordingly, with the present invention, not only can the road and the three-dimensional buildings surrounding the road be plotted at the same time, but also the road covered behind the buildings can also be displayed for the driver. Therefore, the driver can have an accurate understanding of the road as well as the buildings neighboring the road. Accordingly, the present invention not only can provide a satisfactory automobile navigating function, but can also plot a view that closely resembles the actual view of the road and the buildings surrounding the road.

Although the above-described embodiment of the present invention is described applying the present invention to an automobile navigation apparatus, the present invention may also be applied to, for example, a simulator or a video game.

Further, the present invention is not limited to these embodiments, but variations and modifications may be made without departing from the scope of the present invention.

The present application is based on Japanese Priority Application No. 2005-208757 filed on Jul. 19, 2005, with the Japanese Patent Office, the entire contents of which are hereby incorporated by reference.

What is claimed is:

1. An image processing apparatus for displaying a three-dimensional map on a display, the image processing apparatus comprising:
an extracting part for extracting data corresponding to a part of a road covered behind a three-dimensional building by referring to depth information of a target plotting road and a target plotting building; and
an overwriting part for overwriting the data corresponding to the covered road part with color data or pattern data that are distinguishable from color data or pattern data of the target plotting road and the target plotting building.

2. The image processing apparatus as claimed in claim 1, wherein the depth information is obtained from a Z buffer that stores information including the distance between a reference viewpoint and the target plotting road and the distance between the reference viewpoint and the target plotting building.

3. The image processing apparatus as claimed in claim 1, wherein data corresponding to the covered road part are loaded in a stencil buffer, wherein the data of the covered road part are overwritten in a frame buffer based on the data loaded in the stencil buffer.

4. A road image plotting method for an image processing apparatus displaying a three-dimensional map on a display, the method comprising the steps of:
extracting data corresponding to a part of a road covered behind a three-dimensional building by referring to depth information of a target plotting road and a target plotting building; and
overwriting the data corresponding to the covered road part with color data or pattern data that are distinguishable from color data or pattern data of the target plotting road and the target plotting building.

5. A computer-readable recording medium on which a program for causing a computer to execute a road image plotting method is recorded, the road image plotting method comprising the steps of:
extracting data corresponding to a part of a road covered behind a three-dimensional building by referring to depth information of a target plotting road and a target plotting building; and
overwriting the data corresponding to the covered road part with color data or pattern data that are distinguishable from color data or pattern data of the target plotting road and the target plotting building.
